(19) United States
(12) Patent Application Publication
(10) Pub. No.: US 2016/0232410 A1
(43) Pub. Date: Aug. 11, 2016

(54) VEHICLE SPEED DETECTION

(71) Applicants: Michael F. Kelly, Montreal West (CA); David McMordie, Montreal (CA)

(72) Inventors: Michael F. Kelly, Montreal West (CA); David McMordie, Montreal (CA)

(21) Appl. No.: 14/616,115

(22) Filed: Feb. 6, 2015

(51) Int. Cl. G06K 9/00; G06K 9/52; G06K 9/18; G06T 7/20

(52) U.S. Cl. CPC G06K 9/00711; G06T 7/20; G06K 9/52; G06K 9/18

(57) ABSTRACT

Improved systems and methods for determining vehicle speed along a roadway use a precisely timed sequence of images. In various embodiments, vehicle position and speed may be estimated based on geometric knowledge of certain vehicle features unlikely to vary among vehicles, e.g., boundary points along license plate characters and the knowledge that these points are coplanar on intact license plates. Embodiments of the invention facilitate determination of position and speed without requiring any manual calibration or measurement of the camera's position in space with respect to the road surface.

### FIELD OF INVENTION

The invention relates generally to systems and methods for automatic determination of vehicular speed, and in particular, to determining speed based on recognition and tracking of license plates

### BACKGROUND

Autonomous vehicle speed-tracking camera systems are widely deployed and constitute an effective tool in enforcing posted speed limits, improving road safety and providing a revenue source for many jurisdictions worldwide. Such systems have been based, for example, on automatic license plate recognition (ALPR), vehicle counting, vehicle classification and other functions related to traffic management, road safety and security. Conventional systems may include at least one camera that records one or more images of the vehicle for identification and as evidence for enforcement purposes.

Accurate vehicle speed measurement is the core component of any speed enforcement camera system. Typical measurement modalities include Doppler radar and LiDAR, which both sample a vehicle's speed within a short time interval—for example, a few seconds. Other average time-of-travel methods rely on sampling over a much longer interval at two different locations along a road, and may employ ALPR to match vehicle records. The average speed is estimated by taking the distance travelled divided by the time of travel.

Recently, systems have emerged that use computer-vision algorithms to detect a vehicle or vehicle features within a sequence of consecutive video frames. In some instances, grids are painted on the road to provide reference points that allow the vehicle's speed to be estimated based on the time it takes for a vehicle to pass one or more of these reference points. Other recent methods rely instead on the known optics and geometry of the imaging environment to compute a speed measurement based on multiple captured frames.

Conventional autonomous speed-enforcement systems suffer from several drawbacks. Systems that rely on radar may be unable to distinguish among multiple vehicles present within the emitted detection cone and traveling at different speeds. Radar systems are also vulnerable to false detection and false speed measurement in response to fast-moving objects other than the vehicle of interest, notably automotive cooling fans. LiDAR systems employ a much narrower beam than radar systems, and are becoming commonplace in the hand-held enforcement sector. Due to the narrow beam, LiDAR systems are better at estimating the speed of a single vehicle within a group of vehicles; however, they require accurate aiming of the laser beam by a human operator.

Systems based on installed sensors such as piezoelectric strips, electromagnetic loops or electronic eyes are vulnerable to false-positive and false-negative triggers, contributing to uncertainty about the reliability of enforcement. When used to detect violators within a group of vehicles, these systems exhibit the same limitations as radar, and it becomes difficult to associate a sensed speed violation with a particular vehicle in the imaged scene. Systems that rely on installing sensors within a road, or painting markings on the road surface also impose significant installation and maintenance costs.

Newer vehicle speed-enforcement systems estimate speed using the appearance of a vehicle, along with its license plate or other features, that is captured within a precisely timed sequence of images acquired over a very short period of time. These systems mitigate the above-described problems with earlier systems, but tend to exhibit practical limitations of their own. For example, systems that estimate speed based on recorded features may be unreliable due to variation in these features among makes and models of vehicles or due to aftermarket modifications such as license plate borders. Other systems require cumbersome calibration and may be compromised by alteration to the camera's position or attitude (for example, due to maintenance, severe weather or vandalism).

### SUMMARY

The present invention offers improved systems and methods for determining vehicle position along a roadway using a precisely timed sequence of images, thereby allowing for accurate estimation of vehicle speed. In various embodiments, vehicle position and speed may be estimated based on geometric knowledge of certain vehicle features unlikely to vary among vehicles, e.g., boundary points along license plate characters and the knowledge that these points are coplanar on intact license plates. Embodiments of the invention facilitate determination of position and speed without requiring any manual calibration or measurement of the camera's position in space with respect to the road surface. Certain embodiments may utilize redundant calculations that may be combined to produce greater accuracy when estimating position and speed error. Embodiments of the invention may accurately detect and calculate the speed of multiple vehicles present within the field of view simultaneously, and associate the correct speed with each vehicle. Embodiments of the invention may be mounted in a stationary setting, or they may be mounted on a moving vehicle in order to measure the relative speed of passing vehicles. For example, using GPS and/or the speedometer of the vehicle on which the cameras are mounted, it is possible to detect the speed of other moving vehicles using the approach described herein.

Accordingly, in a first aspect, the invention pertains to a method of detecting the speed of motor vehicles. In various embodiments, the method comprises the steps of providing at least one video camera for capturing a series of successive, time-separated images each including, within a field of view of the image, a physical feature of a moving vehicle, the captured feature having at least one known geometric parameter; determining a location of the feature within each of the time-separated images; based on the known geometric parameter of the feature and a geometry of the camera relative to the vehicle, estimating, for each of the time-separated images, a real-world spatial coordinate position of the feature; and based on the estimated real-world spatial coordinate positions of the feature in the time-separated images and a capture time of each of the time-separated images, estimating a speed of the moving vehicle.

In various embodiments, the physical feature contains at least two identifiable feature points. For example, the physical feature may be the top and bottom of at least one character on a license plate of the vehicle, and the method may include the step of determining an actual height of the character by lookup based on characteristics of the license plate. A normalizing transformation may be performed on the image prior to the determining step. The method may include estimating a distance from the camera to the character using ray pairs based on a known physical distance between the features on the license plate. A trajectory that represents the real-world spatial coordinate positions of the features may then be created, and the speed may be estimated by applying a linear or curve-fitting algorithm to the trajectory. In various embodiments, separate trajectories are created for each of the feature points.

Embodiments of the invention may further comprise the step of computing speed and error estimates for each feature point and combining the estimates in order to obtain a single speed and speed-error measurement for the vehicle. In some embodiments the video camera(s) is or are stationary, whereas in other embodiments, it or they are moving.

In another aspect, the invention pertains to a system for detecting the speed of motor vehicles. In various embodiments, the system comprises at least one video camera for capturing a series of successive, time-separated images each including, within a field of view of the image, a physical feature of a moving vehicle, where the captured feature has at least one known geometric parameter; a memory for storing the images; and a processor configured for (i) determining a location of the feature within each of the time-separated images, (ii) based on the known geometric parameter of the feature and a geometry of the camera relative to the vehicle, estimating, for each of the time-separated images, a real-world spatial coordinate position of the feature, and (iii) based on the estimated real-world spatial coordinate positions of the feature in the time-separated images and a capture time of each of the time-separated images, estimating a speed of the moving vehicle.

In various embodiments, the system further comprises a support on which the camera is mounted at a known height, and the processor is configured to estimate the real-world spatial coordinate position of the feature on which the vehicles travel. The processor may be configured to identify at least two feature points in the physical feature, which may be, for example, the top and bottom of at least one character on a license plate of the vehicle. In some embodiments, the system further comprises a network interface and the processor is further configured to determine the actual height of the character by interactive, remote database lookup via the network interface based on characteristics of the license plate.

The processor may also be configured to perform a normalizing transformation on the image prior to determining the location of the feature within each of the time-separated images. In some embodiments, the processor is further configured to create a trajectory that represents the real-world spatial coordinate positions of the features and estimate the speed by applying a linear or curve fit to the trajectory. The processor may create separate trajectories for each of the feature points, compute speed and error estimates for each feature point, and combine the estimates in order to obtain a single speed and speed-error measurement for the vehicle.

### BRIEF DESCRIPTIONS OF THE DRAWINGS

The foregoing discussion will be understood more readily from the following detailed description of the disclosed technology, when taken in conjunction with the accompanying drawings, in which:

FIG. 1 schematically illustrates a generalized deployment configuration for embodiments of the present invention utilized as a speed enforcement and traffic monitoring camera.

FIG. 2 schematically illustrates the basic operative components used to implement an embodiment of the invention.

FIG. 3a illustrates an optical configuration whereby an object's image is projected onto a sensor array.

FIGS. 3b and 3c depict an orthogonal coordinate system used for computations in accordance with embodiments hereof.

FIG. 4 graphically illustrates an approach to locating feature points at the top and bottom of each extracted plate character.

FIG. 5 illustrates the geometry of projecting a group of feature points from the image sensor plane through the lens and onto a sensor plane, illustrating how vehicle range may be determined from the projection of a group of rays, known geometric characteristics of the features, and an additional geometric constraint, e.g., that the license plate is contained within a plane that is orthogonal to the road surface.

FIG. 6 illustrates a precisely-timed trajectory of ordered points in three-dimensional space, from which the direction of travel and speed may be computed. This figure also illustrates the use of a constraint (the parallelism of adjacent displacement vectors) in order to determine when the range estimates are unreliable.

FIGS. 7a and 7b are flowcharts illustrating techniques for velocity estimation in accordance with embodiment of the present invention.

### DESCRIPTION OF THE INVENTION

In general, the operation of an illustrative embodiment of the invention may be understood as follows. Vehicle images are captured from a video camera aimed at the roadway. For each image, its capture time is noted, and any license plates present within the image are localized. In an embodiment, inside each license-plate region, locations are calculated for the boundaries of each license-plate character. “Feature points” are identified at the top and bottom of each character along its vertical center line. Using a pinhole approximation for the lens, rays are traced from the physical location of these feature points on the image sensor, through the lens, and into the scene. By combining the two ray vectors for each pair of feature points with knowledge of the real distance between the feature points on the target vehicle (e.g., the character height), as well as with the fact that the features are coplanar, a system of equations may be solved to yield an estimate of the positions of these feature points in three-dimensional (“real world”) space. With each pair of feature points yielding an independent, three-dimensional estimate of vehicle position for a precisely-timed image, a plate or character trajectory may be calculated based on regression or another fitting technique using the position data as a function of time. These fits then yield an estimate of the vehicle velocity along with an estimated measurement error.

It should be stressed that license plate features other than characters—for example, the license plate height, or the spacing between bolt-holes—can be used.

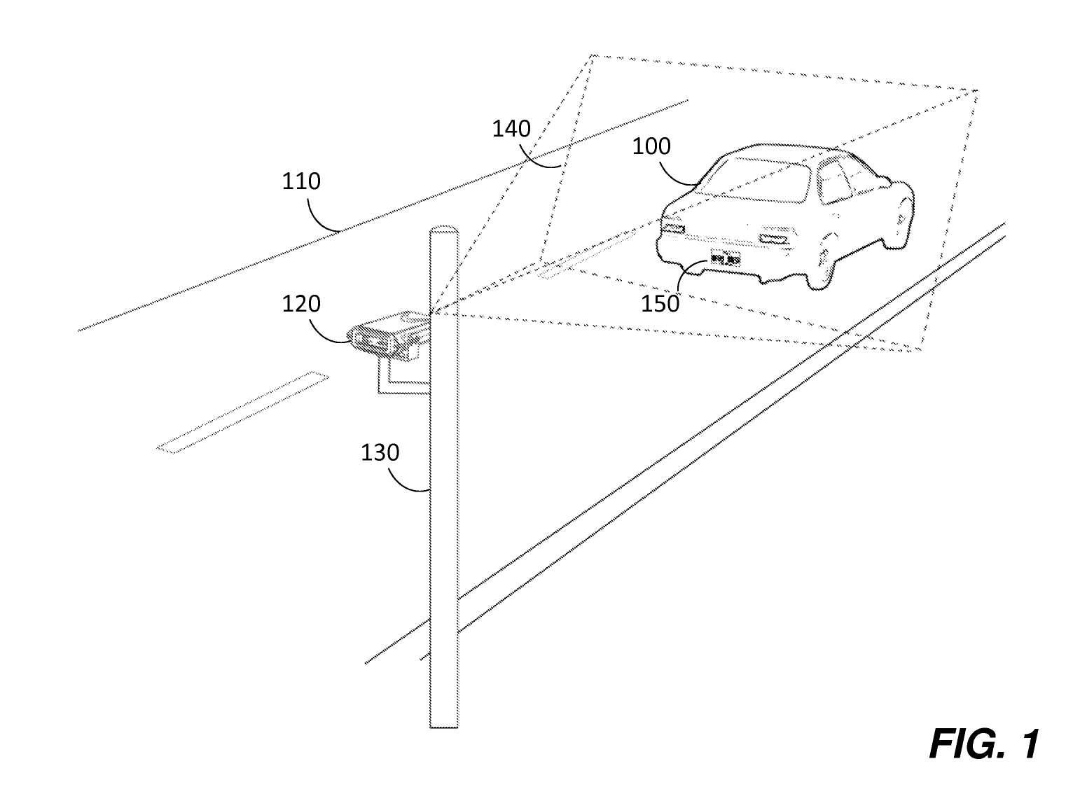

Refer now to FIG. 1, which shows a moving vehicle 100 driving on a road 110 while being monitored by a camera unit 120. In some embodiments, the camera 120 is stationary—e.g., rigidly mounted to a vertical pole 130; in other embodiments, the camera is (or can be) moving. The camera unit's field of view 140 is designed to capture vehicles moving in one or more traffic lanes. The vehicle license plate 150 is visible and is tracked through multiple video frames in order estimate the vehicle speed. In one embodiment, the camera unit 100 may be an integrated camera-and-computer unit, while in others it may contain only video cameras and an illumination source.

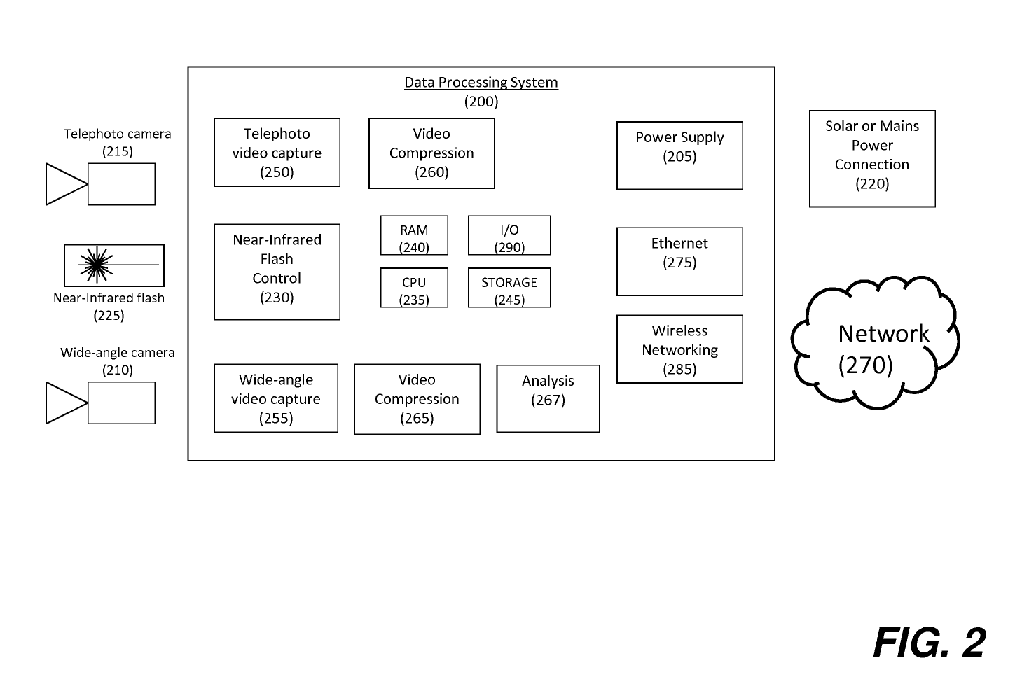

A representative system 200, which includes both the camera and data-processing hardware and software, is illustrated in FIG. 2. The system 200 receives power via an on-board power supply 205, which itself draws power from a solar or utility mains power source 220. Images are acquired using two camera sensors—a telephoto camera 215 having optics that provide a narrow field-of-view, and a wide-angle camera 210 having optics that provide a wide field-of-view. In the illustrated embodiment, the telephoto camera 215 captures images within the near infrared (IR) and visible spectra. A near-IR flash 225 is synchronized with the telephoto camera using a near-infrared flash control 230 such that the illumination pulse occurs concurrently with the camera exposure, allowing license plates to be illuminated for capture at night or during other low-light conditions. Suitable cameras typically contain a CCD or CMOS sensor which permits full-frame exposure to be synchronized with an external illumination source by means of an electronic timing pulse. For CCD sensors this full frame shutter is usually referred to in the context of a “progressive scan” scanning system. For CMOS sensors, full frame electronic shuttering is often referred to as a “global shutter”.

The central processing unit (CPU) 235 executes software implementing various functions and may be or include a general-purpose microprocessor. The system 200 includes volatile and non-volatile storage in the form of random-access memory (RAM) 240 and one or more storage devices 245 (e.g., Flash memory, a hard disk, etc.). Storage may also be expanded by communicating data to a remote storage site. RAM 240 typically contains data and/or program modules that are immediately accessible to and/or presently being operated on by the CPU 235. The data or program modules may include an operating system, application programs, other program modules, and program data.

Images from the two cameras are captured using conventional video-capture modules 250, 255 for the telephoto IR camera 215 and the wide-angle camera 210, respectively. Wide-angle camera images may be taken with a color sensor, and permit a situational view of the roadway including any vehicles being tracked for speed-enforcement, identification or vehicle counting purposes. Images from the wide angle camera may serve to identify the class (e.g., heavy transport vs. passenger vehicle vs. public transit), make, model and color of the vehicle of interest, as well as its position on the road relative to nearby vehicles. This information may be required for ticket issuance purposes, but it may also serve to identify the applicable speed limit (for example, on roads where passenger vehicles and heavy transport vehicles are subject to different speed limits). Vehicle class information may further be used to provide information about license plate issue, character height and grammar in jurisdictions where this information is segregated into distinct rules per vehicle class. For example, public transit vehicles may carry license plates of a particular grammar, size or color, which can therefore affect both the character height (or other speed-detection feature) measurement used for calculation of speed and the accuracy of the license plate read as computed by an OCR system.

The video-capture modules may be separate components or may be included within the video cameras 215, 210. The images may be compressed by one or more compression modules 260, 265, which may utilize any of the many well-known compression techniques, to reduce storage and offload capacity. The compression modules 260, 265 may, for example, be implemented in hardware and receive video data from the camera feeds. Both compressed and uncompressed images from the telephoto camera are stored in RAM 240 (e.g., within frame buffers or other physical or logical partitions). An analysis module 267 performs the various computations described below. The analysis module is typically implemented in software or firmware and is readily coded by one of skill in the art without undue experimentation based on the ensuing description. The analysis module 267 may include suitable computer-vision functionality that operates on the uncompressed telephoto image sequence. This functionality is conventional and locates license plates within images, tracks plates from one image to the next, and extracts plate characters; see, e.g., http://en.wikipedia.org/wiki/Automatic_number_plate_recognition. It should be stressed that the division of functionality among the various illustrated components in FIG. 2 is for illustrative purposes. Those skilled in the art understand that functions can be grouped differently or differently distributed in accordance with routine design choices.

For each tracked vehicle, a sequence of images is captured and associated meta-data is stored therewith. This image set, along with the final speed estimate, may be communicated to a supervisory system via a telecommunications network 270 using either an Ethernet communications channel 275, or via a wireless network interface 285. An I/O module 290 provides communication between the CPU 235 and other hardware devices such as the cameras for the purposes such as synchronization, triggering or power management.

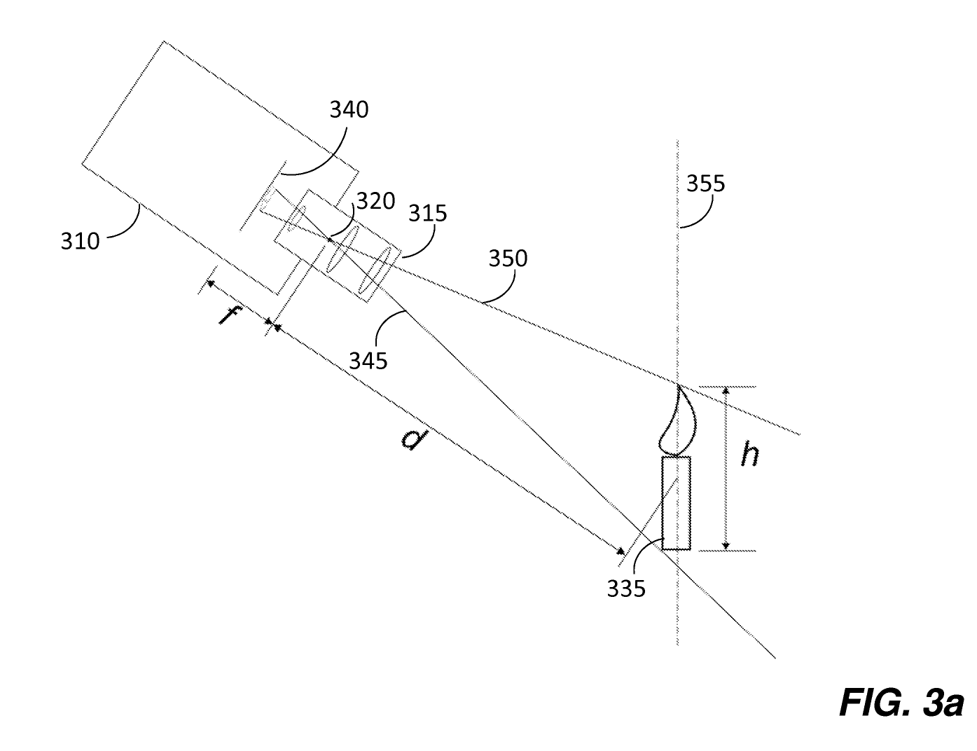

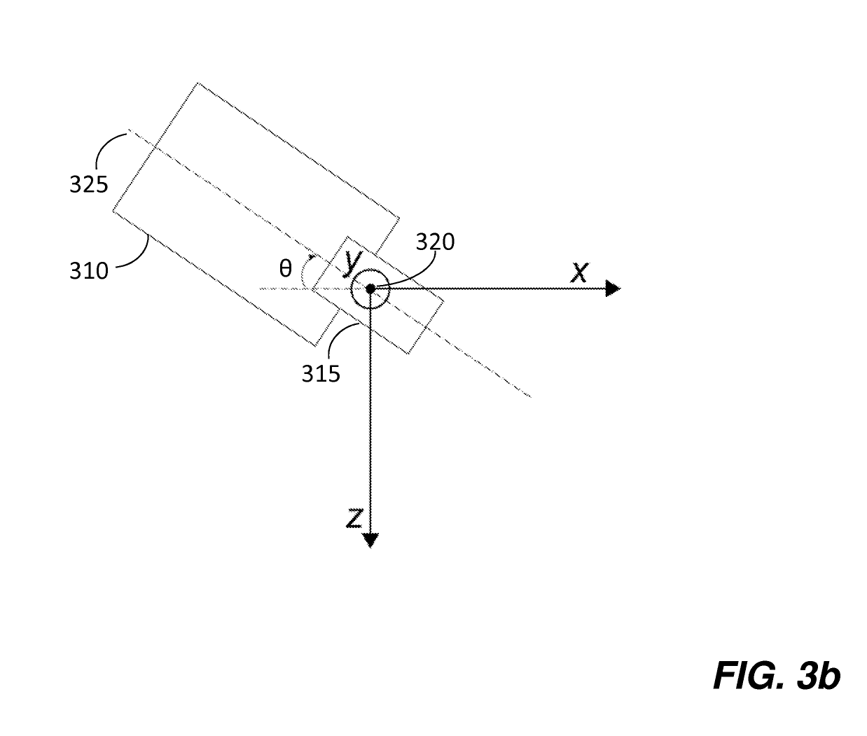

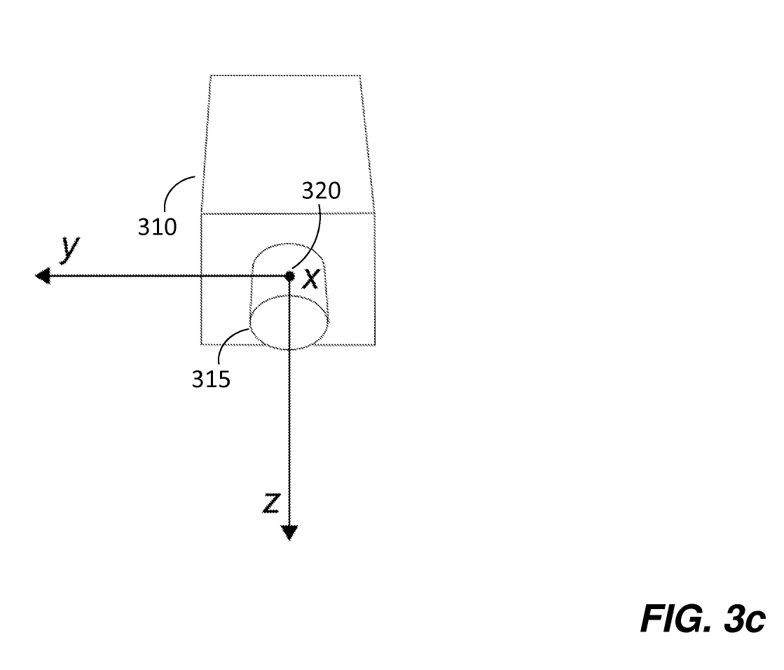

FIGS. 3a-3c illustrate a telephoto camera unit 310 and telephoto lens assembly 315. An orthogonal coordinate system (X,Y,Z) is defined with an origin at the camera's center of projection 320, which represents the effective center of the camera lens, and employs a convenient unit of length. It is assumed that the patch of road being viewed is approximately planar. The XY plane is defined to be parallel to the road patch, and the Z direction is then normal to the road and pointing downwards. The camera 310 is tilted downwards from the XY plane by an angle θ. The Y axis is orthogonal to the optical axis 325. The camera 310 includes a telephoto lens assembly 330, which projects an inverted image of an object 335 onto the camera sensor array 340. The telephoto lens 330 has a focal length f, typically 20-50 mm and usually substantially longer than that of the wide angle lens, as it serves to provide images only of the rear of passing vehicles and does not need to include a contextual view of the roadway scene. Since f represents a long focal length, it is appropriate to use a pinhole approximation, such that light rays 345, 350 emanating from an object 335 all travel through the common center of projection 320 that is a distance f from the sensor array 340.

In most jurisdictions, registered vehicles display at least one license plate, and these may be readily identified within images using well-established ALPR computer-vision methods for plate finding known to persons skilled in the art. Examples of these methods include the detection of spatially-limited regions with a high density of vertical contrast edges, or the application of feature-based methods such as Haar cascades. Embodiments of the invention presume that license plate features be reliably identified within an image, and utilize these to estimate the distance from the camera 120 to the license plate 150 (see FIG. 1) at a given time t. This information is then tracked across a set of precisely timed images in order to estimate a vehicle's speed. To accurately estimate the distance from the camera to a license plate or its characters, the physical distances between the features on the license plate must be known.

In one embodiment, the tracked features are located on the edge or boundary of the license plate—for example, at the four plate corners. The advantage of this approach is that in many jurisdictions, all license plates have a fixed size with a standard width and height. However, plate borders may not always be visible due to occlusion, and the presence of plate vanity-borders may render the detection of actual plate borders unreliable.

In a preferred embodiment, feature points are identified at the top and bottom of each plate character, and the distance between these points (the physical character height) must then be known to within a small tolerance (for example ±0.5 mm). In many jurisdictions, the majority of license plates have a single fixed character height, and this value is used directly when estimating speed. In jurisdictions that utilize a variety of plate character heights (e.g., from surrounding jurisdictions or various plate series), ALPR can be used in conjunction with lookup tables to first detect the jurisdiction (and possibly series) of issuance of the license plate based on characteristics of the plate and/or characters recorded on the image (e.g., from the wide-angle camera 210), and then to determine the corresponding character height for the identified plate type.

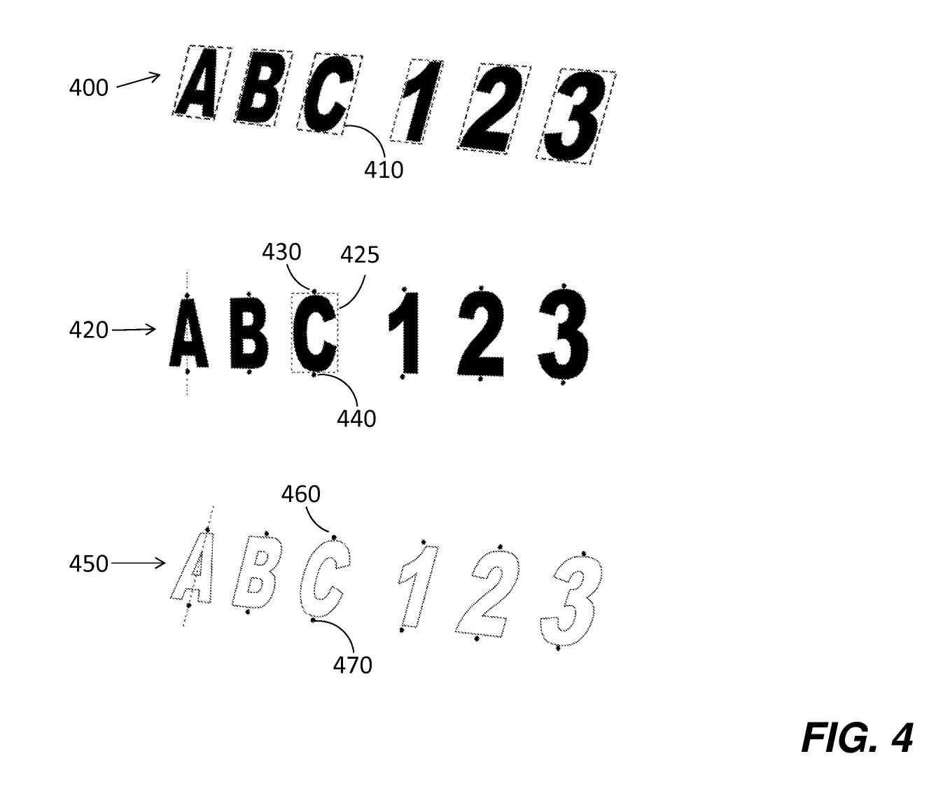

Standard ALPR tools, implemented in the analysis module 267 (see FIG. 2), are used to locate all license plates within a given image and, for each plate region, to then locate all associated character regions. FIG. 4 illustrates an embodiment in which unique features corresponding to points at the top and bottom of each character are identified by the analysis module 267. A license plate string (ABC123), indicated at 400, has characters that exhibit typical imaging artifacts including rotation, shear and perspective distortion. Each character is contained within a quadrilateral bounding box 410 (dashed). The analysis module 267 establishes top and bottom feature points on each character by performing a normalizing transformation that results in a set of upright characters, indicated at 420, with rectangular bounding boxes 425 (dashed) as shown for the character ‘C’. The normalizing transformation is an affine operation that combines a rotation and a shear component, and these are both computed directly from the extracted character regions using conventional computer-vision techniques. For example, plate characters may be first identified through a binarization process applied within each license plate sub-image. A line is then constructed through the center of all character regions and used to estimate string rotation. Shear is detected on a de-rotated string though an iterative process that finds a horizontal shear value that minimizes the combined character widths. For the normalized character bounding box 425, the midpoints of the top and bottom edges (points 430 and 440, respectively) are assigned as a feature points for this character. All feature points are transformed back into the original image space as indicated at 450 using the inverse of the normalizing transformation. The pair of top and bottom points 460, 470 is shown for the character ‘C’. Pairs of top and bottom points for each character are then used to estimate the location of a given character in three-dimensional space as outlined below.

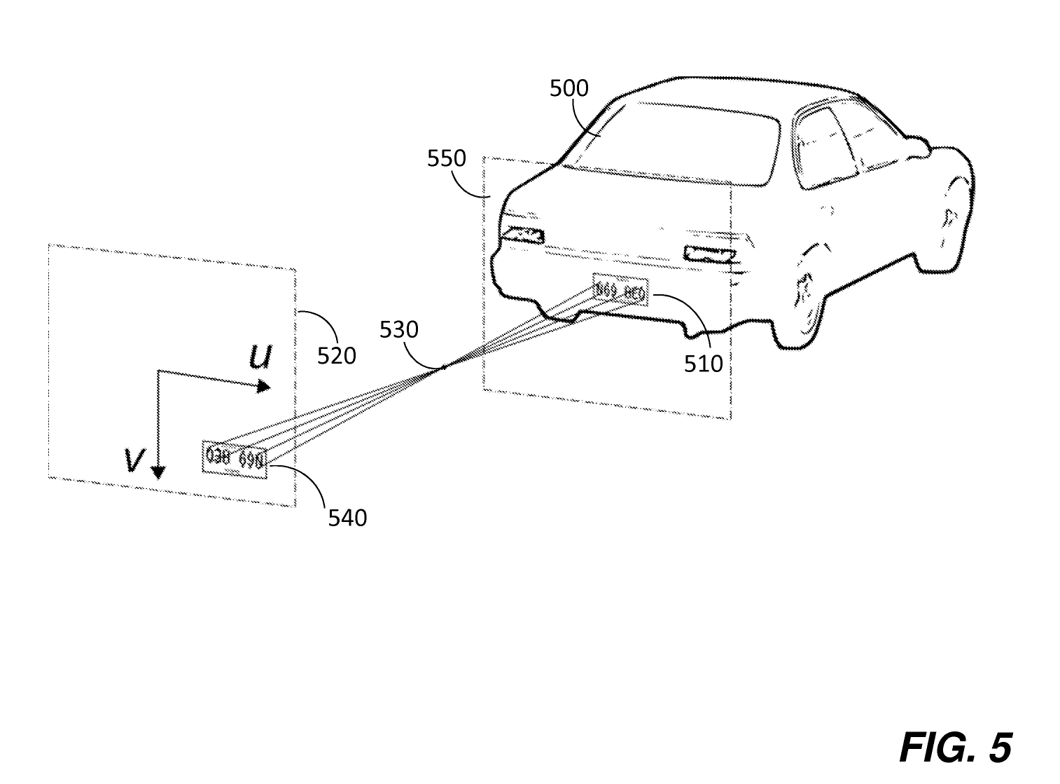

FIG. 5 illustrates a vehicle 500 with a license plate 510. The image captured by the camera is shown on a sensor array plane 520. Rays from feature locations on the actual license plate 510 extend through the camera's center of projection 530 and intersect the sensor imaging plane 540 and give rise to corresponding feature points in the acquired image. The direction from the feature point on the sensor to the actual plate feature location in three-dimensional space is determined as follows. A two-dimensional coordinate system (u,v) is defined on the sensor array 540 with its origin at the center of the array, and employing the same unit of length as the X,Y,Z coordinate system described above. With reference to the coordinate system u,v, the direction of the optical axis is defined by the vector A=(cos θ, 0, sin θ) where θ is the tilt angle. Since A is normal to the sensor array plane, direction vectors u and v are defined as follows:

u=(0,1,0) (1)

v=Op×u=(−sin θ,0,cos θ) (2)

where Op is the optical axis and x represents a vector cross product. Each of the extracted feature points having an image pixel coordinate (i,j) may be directly converted into u,v space coordinates based on a translation and a scaling computed from the sensor's physical height (or width) divided by its height (or width) in pixels. For each feature point at image pixel location (i,j), a corresponding physical sensor location (uᵢ,vⱼ) is represented in terms of the (u,v) coordinate system. The position vector locating the sensor array (u,v) origin relative to the (X,Y,Z) real-world origin is given by:

Cᵤᵥ=−fA (3)

where f is the lens focal length. A ray r is extended from a given feature point (uᵢ,vⱼ) through the center of projection as follows:

r=(0,0,0)−(Cᵤᵥ+uᵢ+vⱼ)=(fA)−uᵢ−vⱼ (4)

The resulting ray points directly towards the corresponding license plate feature location in three-dimensional space. Using pairs of features with a known separation in three-dimensional space, the ray pairs are used to estimate the distance from the camera to the plate character.

The following discussion assumes that the physical height of plate characters (equivalent to the distance between each pair of extracted feature points) is known to be h. Consider one pair of feature points. Let the normalized ray extending from the sensor to the top feature point be represented by a unit direction vector T=(Tₓ,T_{y},T_{z}), and similarly for the bottom point, a unit direction vector B=(Bₓ,B_{y},B_{z}). The actual feature points in three-dimensional space are then defined as:

Pₜ=tT (5)

P_{b}=bB (6)

where t and b are scalar values representing the distance from the camera origin to the top and bottom feature points respectively. Let the vector between the two feature points on the license plate be defined as:

V=(Vₓ,V_{y},V_{z})=P_{b}−Pₜ. (7)

The distance between the two character points in three-dimensional space is equivalent to the character height h, as follows:

∥V∥²=Vₓ²+V_{y}²+V_{z}²=h² (8)

In one embodiment, it is assumed that the license plate is contained within a plane 550 that is orthogonal to the road surface, and is represented by the YZ plane rotated about the Z axis by an angle φ. This plane has a normal vector:

n=(−cos φ,−sin φ,0) (9)

Since V is within the plane containing the license plate, it is orthogonal to n, and the vector dot-product between the two is zero:

n·V=0 (10)

Through substitution, the equations (8) and (10) can be solved closed-form to calculate the scalar distance values t and b given the known direction vectors T and B and a plane rotation angle φ. Note that the rotation angle φ is related to the camera pan angle relative to the direction of travel and may be estimated over time based on previously computed trajectories.

The embodiment outlined above is based on computing distances one character at a time. Another embodiment involves solving a global optimization problem where all top and bottom feature points are constrained to lie within a common plane. A closed-form solution for this optimization is yet not available using conventional mathematical techniques, and hence, an iterative implementation is utilized. All of these operations are performed by the CPU 235 described above. Another embodiment relaxes the constraint that the plane containing the license plate must be normal to the road surface patch. This approach takes advances of the observation that on almost all vehicles, the license plate is sometimes tilted slightly forward from the vertical. In this case, the plane containing the plate or its characters may be again identified by a constant pan angle φ, but for each detected plate a separate (and unique) plate inclination angle γ is computed as part of the optimization, which, again, is obtained iteratively to arrive at a single solution based on all character pairs.

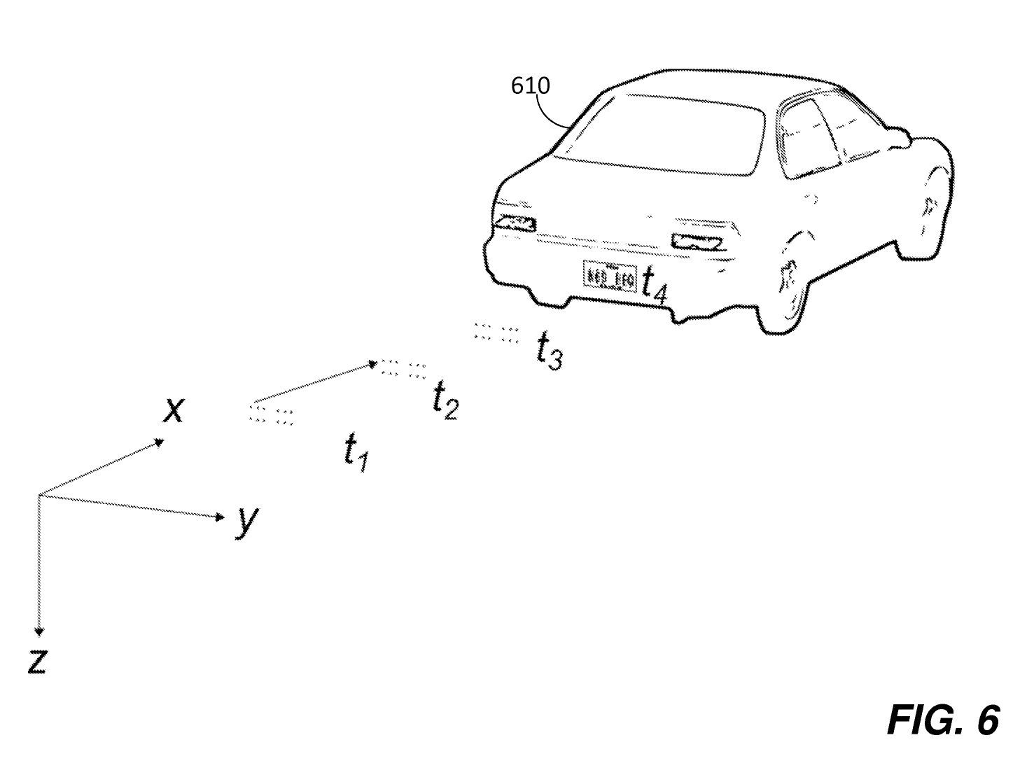

Using the approach outlined above, at a given time t, points in three-dimensional space are estimated based on features that can reliably be extracted using image processing so long as the physical distance between features on the license plate is known. The method can also be generalized to use other license-plate features such as the license plate height when appropriate. To estimate a vehicle speed, three-dimensional feature points are extracted from a precisely timed image sequence as illustrated in FIG. 6. Images of a vehicle 610 have been acquired at times t₁, t₂, t₃, and t₄. The top and bottom feature points in three-dimensional space are also shown for times t₁-t₃. Between each consecutive pair of images, standard computer-vision techniques are used by the analysis module 267 to link image regions associated with the same character so that character regions (and hence feature points) are tracked from one frame to the next.

Tracking implementations may employ optical character recognition (OCR) and symbolic matching of the plate strings, or methods such as template-matching of character sub-image regions. For a given character, the result is a trajectory of three-dimensional points represented as a function of time. In FIG. 6, the corresponding top and bottom points for each character are tracked as they move from one image to another. In one embodiment, at a given time t₄, the current vehicle velocity is estimated based on the following two assumptions: (a) the vehicle trajectory is approximately linear, and (b) the vehicle speed is approximately constant during its transit through the field of view. These assumptions are reasonable in many enforcement settings, and require that camera not be installed to monitor vehicles while travelling around corners.

In other embodiments it may be appropriate to relax the first (linear trajectory) constraint when monitoring vehicles travelling around corners for example or when the camera is deployed in a mobile (non-stationary) setting. In this case, similar operations are performed using a curved trajectory model.

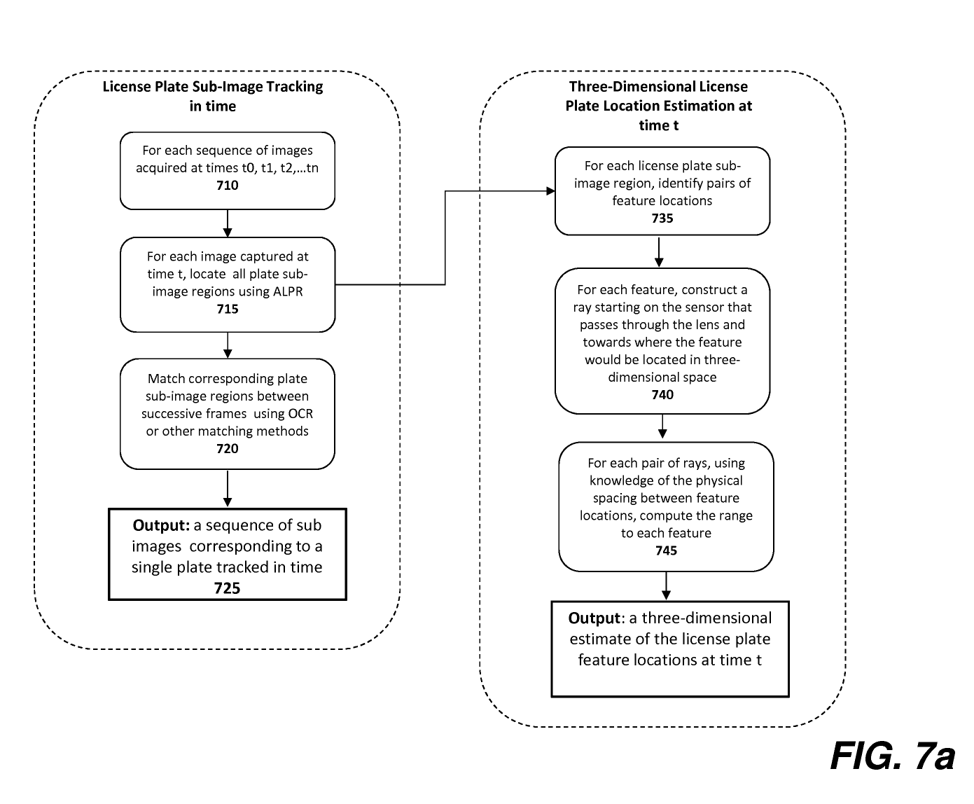

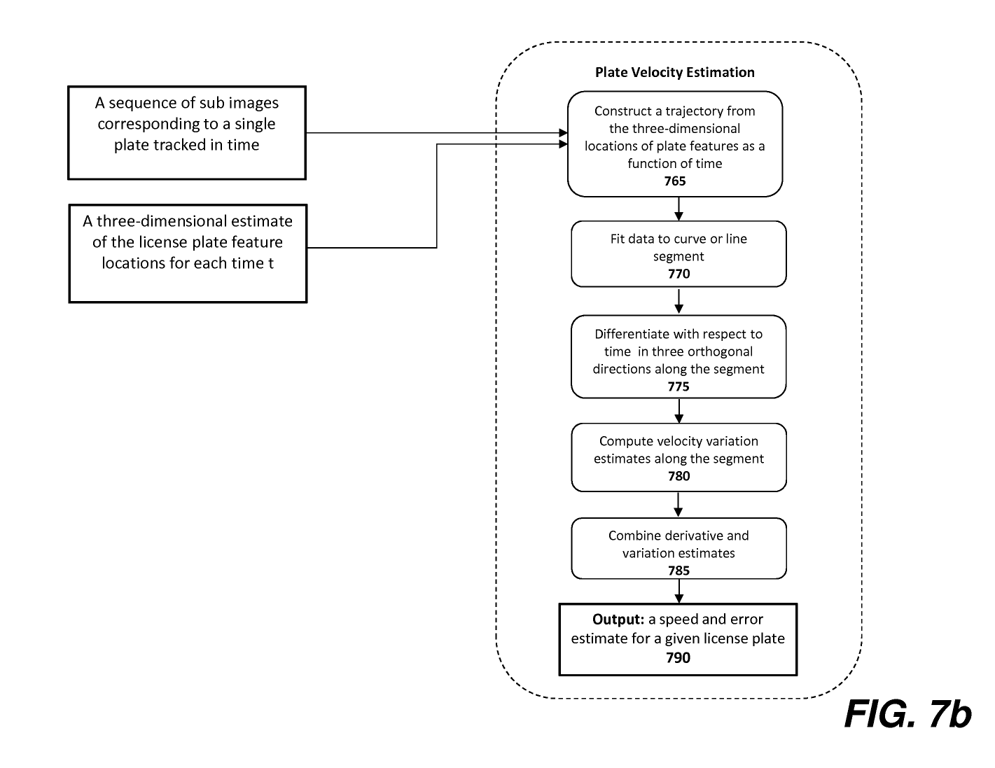

FIGS. 7a and 7b summarize a representative order of operations. In FIG. 7a, individual license plates are tracked within the time sequence of captured images that has been acquired with a range of times (step 710). License plate sub-image regions are identified using standard ALPR methods (step 715), and plate sub-image regions between consecutive images are matched for each individual plate (step 720). The output of this process is a sequence of license plate sub-images associated with each plate in the scene (step 725). The three-dimensional location of license plate features is thereby obtained. For a given plate, feature pairs are identified within a given image (step 735). From the sensor location of each feature, a ray is constructed which passes through the camera lens, and points towards where the feature would be located in three-dimensional space (step 740). The distance along each ray is then computed based on knowledge of the physical distance between the features on the license plate (step 745).

There are various embodiments whereby these distances may be estimated. The output of this process is a set of estimated license plate feature locations in three-dimensional (real-world) space. The final process is depicted in FIG. 7b, where the velocity of the plate is estimated. The inputs to this process are the matched license plate image sequence and the three-dimensional estimate for each license plate feature. These are used to create a trajectory that represents the three-dimensional spatial feature locations as a function of time (step 765). A linear or space-curve model is selected, and the data is fit using standard regression or other curve-fitting methods (step 770) in order to estimate the velocity of the plate in three orthogonal directions based on the derivative of the trajectory as a function of time (step 775). An estimation error is computed based on applying a standard error measure to either the variation in velocity estimates or the deviation of the source data along the fitted line or curve segment (step 780). Final speed and error estimates are made though a vector combination of the three components (step 785) to result in a final system speed and speed error estimate (step 790). This value may be appended to one or more of the vehicle images as metadata, and the annotated image sent via the network 270 to a governmental authority or other supervisory destination.

There is redundancy in the estimated character position data that is computed at each time, and there are various ways to take advantage of this. In one embodiment, the trajectory for each character feature point is treated independently. The character velocity in the X, Y, and Z directions is computed by applying a linear regression fit to the point locations as a function of time, and using the slope of the line to estimate speed. Outlier rejection may be used to enhance the accuracy of the estimate—for example, by excluding points that are not consistent with a linear trajectory, or excluding entire trajectories when they are not parallel to the majority of other trajectories. The error for each character trajectory in each direction is estimated based on the standard error associated with the slope estimates. Speed and error estimates for each feature point are combined in order to obtain a single speed and speed-error measurement for the tracked license plate. In one embodiment, for each trajectory, the three orthogonal speed and error vectors are first combined through vector addition. The speed values are then averaged to compute the plate speed, and the error values may be either averaged or combined using other metrics, such as the maximum value, in order to represent the plate speed error.

In another embodiment, the plate location at a given time is estimated by taking the average of individual character feature point estimates. Again, outlier rejection may be employed to discard feature points that are not consistent with known properties of a license plate or its characters. For example, the set of top or bottom feature points must be aligned. At each time, a single three-dimensional point representing the plate location is thereby established. These points are then combined over time using a three-dimensional linear regression as outlined above in order to arrive at a single speed and error measure based on a vector combination of the values in each direction.

Once a set of character or plate trajectories has been computed, it is possible to make a coarse estimation of the camera pan angle (relative to the vehicle's direction of travel), and its tilt angle θ (relative to the road surface). As noted above, in one embodiment, the pan angle is equivalent to the plane rotation angle φ used when estimating the distance between the camera and a given set of feature points assuming the plate lies in a plane orthogonal to the road surface patch. When a speed enforcement system is started for the first time, the pan and tilt angles are initialized to approximate values. In one embodiment where the trajectories are modeled as a linear segment in space, the tilt angle estimate θ is adjusted such that the angle between this segment and the XY plane is zero, and the angle between the vertical plane containing the linear segment and the YZ plane represents an estimate for the camera pan angle. In another embodiment when trajectories are modeled as planar curves, the tilt angle estimate θ is adjusted such that the angle between the plane containing the curves and the XY plane is zero, and the pan angle is estimated by computing the angle between the average tangent direction on the curve segment and the YZ plane. Over time, for each passing vehicle, these values are used to iteratively update the pan and tilt values used in the computations above (equations 1-10). Within small number of iterations, the accuracy of speed estimation converges to within an acceptable range for enforcement.

Examples and configurations discussed within this text are intended to illustrate the realization of various embodiments of the invention and should not be taken to limit the scope of the invention or of its embodiments. The embodiments described herein refer to the accompanying figures and to the numbered items labeled on these figures. As may be appreciated by one skilled in the art, the present invention may be embodied in a variety of ways, including as a computer program, as a hardware implementation, and as a combination of computer hardware and software, so long as the system chosen implements the processes and methods described herein in their essence. Computer code implementing the method described herein may be written in any computer language (for example, C++, Java or C), or implemented directly in assembly code or machine language. This program code may be executed directly on the data processing equipment as compiled machine code, or interpreted through an interpreter or virtual machine. The methods described herein may also be written in a hardware description language such as VHDL or Verilog, from which it may be implemented in hardware. The data processing equipment described in this disclosure may be connected directly to the camera equipment used for image capture, or remotely located so that image data is captured in one location and transmitted to another for processing. Components described in this disclosure may be connected directly using electric circuits, via optical cable or free-space links or via radio frequency communications channels. All of these mechanisms are collectively described as network connections.

Although the present invention has been described with reference to specific details, it is not intended that such details should be regarded as limitations upon the scope of the invention, except as and to the extent that they are included in the accompanying claims.

What is claimed is:

1. A method of detecting the speed of motor vehicles, the method comprising the steps of:
providing at least one video camera for capturing a series of successive, time-separated images each including, within a field of view of the image, a physical feature of a moving vehicle, the captured feature having at least one known geometric parameter;
determining a location of the feature within each of the time-separated images;
based on the known geometric parameter of the feature and a geometry of the camera relative to the vehicle, estimating, for each of the time-separated images, a real-world spatial coordinate position of the feature; and
based on the estimated real-world spatial coordinate positions of the feature in the time-separated images and a capture time of each of the time-separated images, estimating a speed of the moving vehicle.

2. The method of claim 1, wherein the physical feature contains at least two identifiable feature points.

3. The method of claim 2, wherein the physical feature is the top and bottom of at least one character on a license plate of the vehicle.

4. The method of claim 3, further comprising the step of determining an actual height of the character by lookup based on characteristics of the license plate.

5. The method of claim 1, further comprising the step of performing a normalizing transformation on the image prior to the determining step.

6. The method of claim 3, further comprising estimating a distance from the camera to the character using ray pairs based on a known physical distance between the features on the license plate.

7. The method of claim 6, further comprising the step of creating a trajectory that represents the real-world spatial coordinate positions of the features.

8. The method of claim 7, wherein the speed is estimated by applying a linear or curve-fitting algorithm to the trajectory.

9. The method of claim 7, wherein separate trajectories are created for each of the feature points.

10. The method of claim 9, further comprising the step of computing speed and error estimates for each feature point and combining the estimates in order to obtain a single speed and speed-error measurement for the vehicle.

11. The method of claim 2, wherein the feature points are the tops and bottoms of a plurality of characters on a license plate of the vehicle.

12. The method of claim 1, wherein the at least one video camera is stationary.

13. The method of claim 1, wherein the at least one video camera is moving.

14. A system for of detecting the speed of motor vehicles, the system comprising:
at least one video camera for capturing a series of successive, time-separated images each including, within a field of view of the image, a physical feature of a moving vehicle, the captured feature having at least one known geometric parameter;
a memory for storing the images; and
a processor configured for (i) determining a location of the feature within each of the time-separated images, (ii) based on the known geometric parameter of the feature and a geometry of the camera relative to the vehicle, estimating, for each of the time-separated images, a real-world spatial coordinate position of the feature, and (iii) based on the estimated real-world spatial coordinate positions of the feature in the time-separated images and a capture time of each of the time-separated images, estimating a speed of the moving vehicle.

15. The system of claim 14, wherein the processor is further configured to identify at least two feature points in the physical feature.

16. The system of claim 15, wherein the physical feature is the top and bottom of at least one character on a license plate of the vehicle.

17. The system of claim 16, further comprising a network interface, the processor being further configured to determine an actual height of the character by interactive, remote database lookup via the network interface based on characteristics of the license plate.

18. The system of claim 14, wherein the processor is further configured to perform a normalizing transformation on the image prior to determining the location of the feature within each of the time-separated images.

19. The system of claim 14, wherein the processor is further configured to create a trajectory that represents the real-world spatial coordinate positions of the features and estimate the speed by applying a linear or curve fit to the trajectory.

20. The system of claim 19, wherein the processor is configured to (i) create separate trajectories for each of the feature points, (ii) compute speed and error estimates for each feature point, and (iii) combine the estimates in order to obtain a single speed and speed-error measurement for the vehicle.

21. The system of claim 15, wherein the feature points are the tops and bottoms of a plurality of characters on a license plate of the vehicle.
